(19) United States
(12) Patent Application Publication
(10) Pub. No.: US 2001/0029904 A1
(43) Pub. Date: Oct. 18, 2001

(54) Spinning toy for pets

(76) Inventor: Charles A. Viola, Fairfield, IA (US)

Correspondence Address: CHARLES VIOLA, 511 SOUTH 2ND STREET, FAIRFIELD, IA, 52556, US

(21) Appl. No.: 09/878,472

(22) Filed: Jun. 11, 2001

Related U.S. Application Data
(63) Continuation-in-part of application No. 09/395,441, filed on Sep. 14, 1999, now abandoned.

(51) Int. Cl. A01K 29/00

(52) U.S. Cl. 119/707

(57) ABSTRACT

A toy for pets (10) having a central hub (12) which is convex in shape. A plurality of appendages (14) are immovably connected to the central hub (12) and radiate from it in a single plane. Each appendage (14) has a knob (16) immovably connected at its outer end. The knobs (16) are convex in shape and are smaller in size than the hub (12). When manipulated by the paw of a pet, the device (10) can be made to spin or slide across a smooth surface (18) such as a floor, with the central hub (12) remaining in contact with the surface (18). The convex shape of the central hub (12) minimizes contact with the surface (18) and also provides a pivot point for the device (10) to rotate upon the surface (18). The appendages (14) and knobs (16) may be gnawed or chewed by the pet, grasped by the paws of the pet, or gripped by the mouth of the pet in order to carry the device (10).

This application is a Continuation in Part of application Ser. No. 09/395,441

### FIELD OF INVENTION

The disclosed invention is a novel pet toy, intended primarily for use by cats.

### DESCRIPTION OF PRIOR ART

There are many pet toys which provide a means of amusement to cats and their owners. Some of these toys involve the cat's natural tendency to bat and chase small objects, or to bite them, but all of these toys are limited in the range of play patterns they allow.

No prior pet toy effectively accommodates all of the following play patterns of cats: spinning the toy; sliding the toy across a surface such as a floor; gnawing the toy; and carrying the toy in the mouth.

U.S. Pat. No. 5,207,420 to Crawford & Crawford teaches a toy for pets which is not well suited for spinning or sliding. It also lacks the knobs included on the applicant's invention which allow for more effective gnawing and chewing. U.S. Pat. No. 4,919,083 to Axelrod shows a pet toy which is primarily intended to be thrown by a person during interactive play. When used by the pet alone, it does not allow a wide range of play activities. U.S. Pat. No. 3,198,173 to Fisher, U.S. Pat. No. 3,441,001 to Fisher, and U.S. Pat. No. Des. 238,387 to Rosenberg all show devices which cannot spin and cannot be easily made to slide by the pet across a smooth surface. U.S. Pat. No. 5,269,256 to Viola teaches a pet toy which accommodates a wide variety of play patterns, but cannot be made to spin.

### OBJECTS AND ADVANTAGES

The present invention represents a novel form of cat toy in that it provides the cat the opportunity to cause the device to spin. Even a gentle touch of the cat's paw causes the device to spin in a lively manner which cats seem to find interesting. The unique shape of the toy allows it to slide easily across a smooth surface such as a floor, making it easy for the cat to set the toy in motion in order to chase after it. Further, the device includes small knobs on the ends of its appendages which the cat may chew or gnaw and which provide a means by which the toy can be firmly grasped in the cat's mouth and dragged or carried around. Additionally, as the toy spins or slides with its convex central hub remaining in contact with the floor surface upon which it moves, the knobs tend to brush or hit intermittently against the floor surface, producing a faint scratching or pitter-patter sound, which seems to increase the interest of the cat.

### DRAWINGS

FIG. 1 is a perspective view of a spinning toy for pets;

FIG. 2 is a top plan view thereof;

FIG. 3 is a side elevational view thereof;

FIG. 4 shows the invention being manipulated by paw of cat;

FIG. 5 shows the invention being bitten by cat; and

FIG. 6 shows top plan views of alternative embodiments of the invention.

### REFERENCE NUMERALS IN DRAWINGS

10 device

12 hub

14 appendage

16 knob

18 surface upon which the device may be used

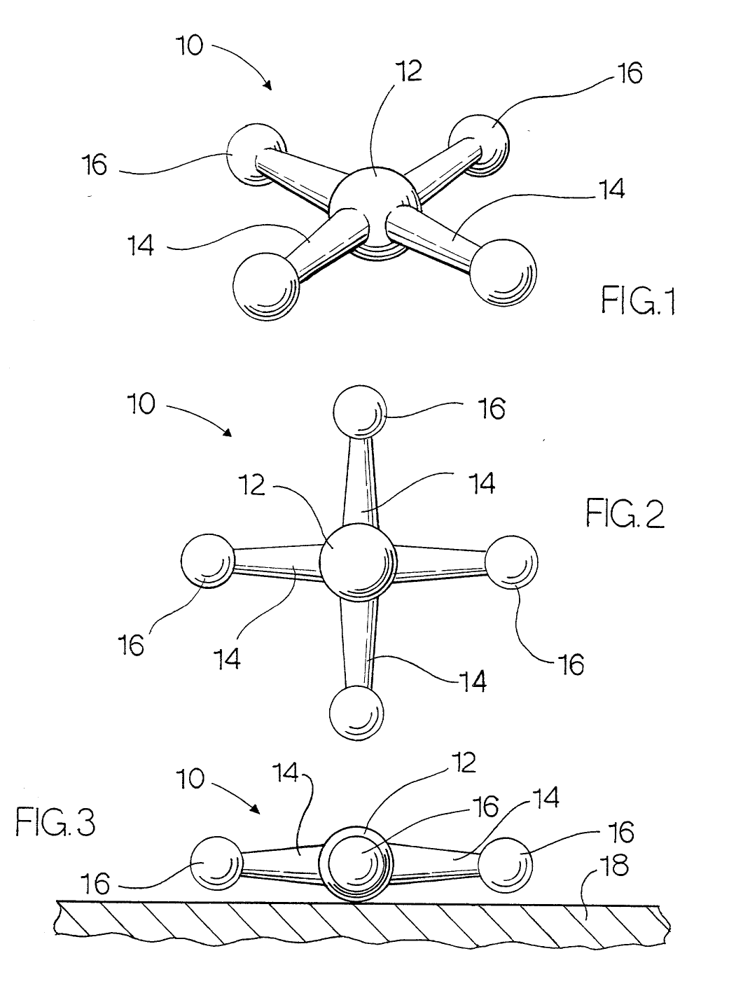

### DESCRIPTION—FIGS. 1-3

The device 10 comprises a central hub 12 from which radiate outwardly, in a single plane, a plurality of appendages 14. Each appendage is immovably connected to the central hub and has a knob 16 immovably connected at its outer end. The hub 12 is convex in shape, minimizing contact with the surface 18 upon which it slides, thereby allowing the device 10 to slide easily. The convex shape of the hub 12 also provides a pivot point in contact with the surface 18 upon which it spins, thereby allowing the device 10 to spin freely. The knobs 16 are slightly smaller than the hub 12 so that they do not tend to remain in continuous contact with the surface 18 upon which the device 10 is set in motion, yet are similar enough in size to the hub 12 so as to occasionally contact the surface 18 when the device 10 is slightly tilted.

The device 10 is reflexively symmetrical with reference to the plane in which the appendages 14 are situated, allowing the toy to perform in an identical manner whether it is upside down or right side up.

In the preferred embodiment, shown in FIGS. 1-5, the hub 12 and knobs 16 are spherical or global in shape.

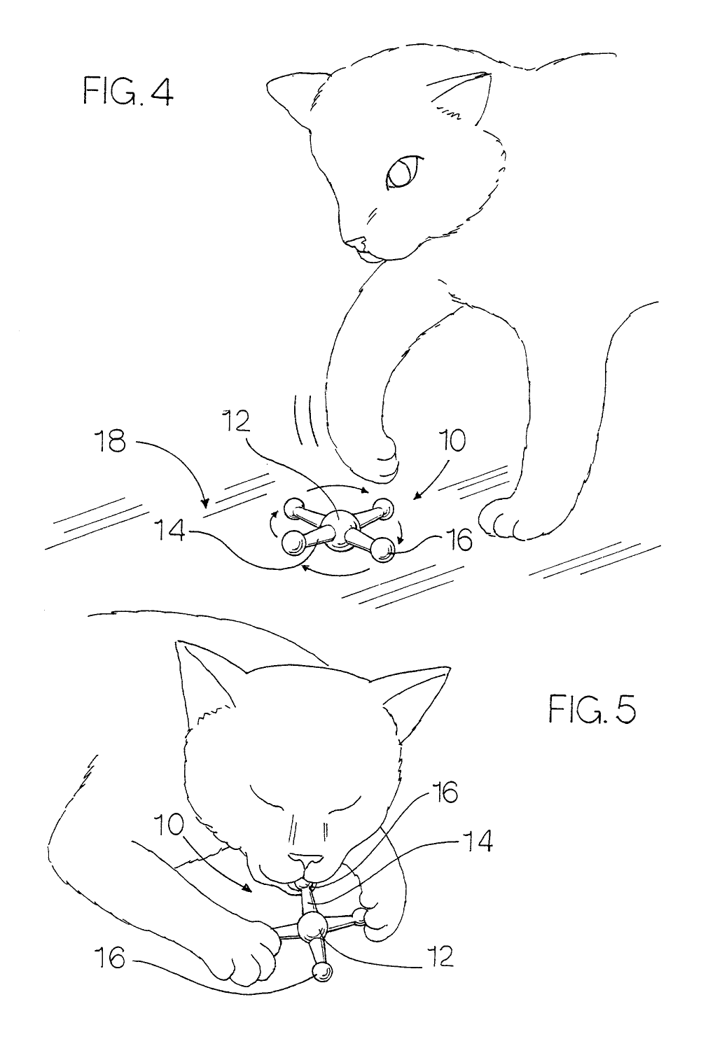

### OPERATION—FIGS. 4-6

The device 10 may be used in a variety of ways. As shown in FIG. 4, a glancing touch from the paw of the pet upon one of the appendages 14 or knobs 16 of the device 10 may cause the device 10 to rotate upon the axis of the central hub 12. The central hub 12 remains in contact with the surface 18 upon which it rotates, while the device 10 moves in a spinning motion which is generally horizontal to the surface 18 upon which it spins. A stronger, more direct touch from the paw of the pet will cause the device to slide across a relatively smooth surface 18 such as a floor. While sliding, the central hub 12 remains in contact with the surface 18. The sliding device may then be chased by the pet. By striking the device with the paw in different ways, the pet can cause it to perform various maneuvers.

When the rotation of the device 10 upon a smooth surface 18 is slow enough as to allow the device to tilt or wobble, the knobs 16 come into contact with the surface 18 in a bouncing, glancing, or scratching manner, thereby producing a soft scratching or pitter-patter sound.

The appendages 14 and knobs 16 provide means for the pet to better grip the device 10 in its mouth while biting or gnawing the device, as shown in FIG. 5, or while carrying or dragging the device with its mouth. As also shown in FIG. 5, the appendages 14 and knobs 16 provide a means for the pet to grasp the device with its paws, while chewing it or while pushing or pulling it about.

### SUMMARY, RAMIFICATIONS, AND SCOPE

Disclosed herein is a unique pet toy which allows a wide range of play patterns. Although the present invention is primarily intended for use by cats, it may made in various sizes so as to be used in a similar manner by other pet animals such as ferrets or birds. Dogs can also play with the present invention in various ways including chewing, tug-of-war, and toss-and-catch games.

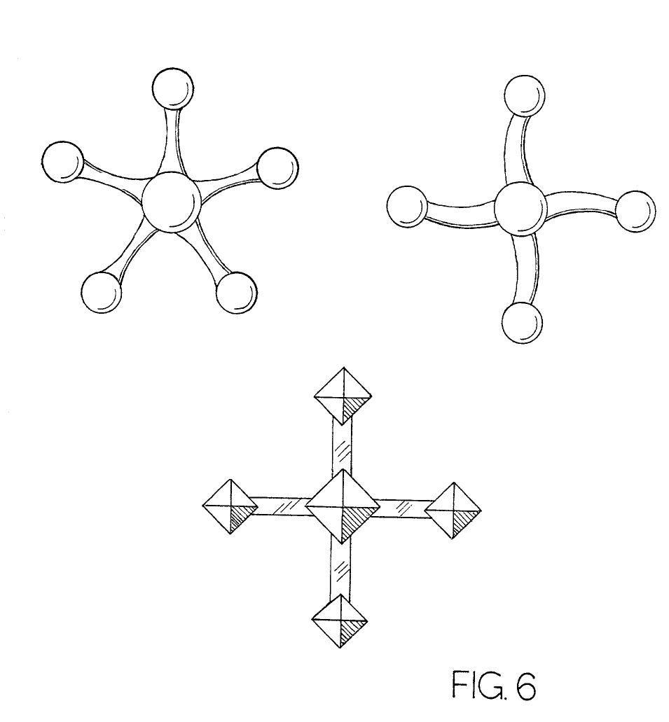

Various embodiments of the disclosed invention may be contemplated. As indicated in FIG. 6, the number of appendages and knobs may be fewer or greater than the preferred embodiment and the shape and size of the appendages and knobs, as well as the hub, may vary from the preferred embodiment, without changing the nature and function of the invention. Therefore, the scope of the invention should be determined by the appended claims and legal equivalents, is not limited to the illustrations or examples provided.

What is claimed is:

1. A toy for pets comprising
(a) a central hub which is convex in shape and large enough to contact the surface upon which the device rests, slides, or spins; said central hub being a pivot upon which the device may rotate;
(b) a plurality of appendages and knobs which may be grasped or bitten by the pet;
(c) said appendages radiating in a single plane from said central hub;
(d) each appendage being immovably connected at one end to said central hub and immovably connected at its other end to one of said knobs;
(d) Said knobs being convex in shape and smaller in diameter than the central hub.
